(19) United States
(12) Patent Application Publication
(10) Pub. No.: US 2020/0412603 A1
(43) Pub. Date: Dec. 31, 2020

(54) METHOD AND SYSTEM FOR MANAGING TRANSMISSION OF PROBE MESSAGES FOR DETECTION OF FAILURE

(71) Applicant: TELEFONAKTIEBOLAGET LM ERICSSON (PUBL), Stockholm (SE)

(72) Inventors: Xuejun CAI, Täby (SE); Joacim HALÉN, Sollentuna (SE); Wolfgang JOHN, Haninge (SE); Mina SEDAGHAT, Solna (SE)

(21) Appl. No.: 16/975,185

(22) PCT Filed: Mar. 9, 2018
(86) PCT No.: PCT/SE2018/050225

§ 371 Date: Aug. 24, 2020

(51) Int. Cl. H04L 12/24; H04L 12/26

(52) U.S. Cl. CPC H04L 41/0677; H04L 43/10; H04L 43/0811; H04L 41/12

(57) ABSTRACT

A method and a system for managing transmission of probe messages for detection of failure in at least one of a first node, a second node and a third node are disclosed. Said each node generates a respective probe list according to a procedure taking said each node and the member list as input, thereby configuring said each node for transmission of a respective probe message in a set of time intervals for transmission of the probe messages, wherein a set of probe lists comprises the respective probe list for said each node. Said each node transmits the respective probe message to a respective node of the nodes according to the respective probe list generated by the procedure. The procedure ensures that the set of probe lists causes said each node to be probed in each time interval of the set of time intervals and by only one other node of the nodes in said each time interval. A corresponding computer program and a computer program carrier are also disclosed.

### TECHNICAL FIELD

Embodiments herein relate to failure detection in a node of a network, such as a computer network, a communication network, a core network of a mobile communication system or the like. In particular, a method and a system for managing transmission of probe messages for detection of failure in at least one of a first node, a second node and a third node are disclosed. A corresponding computer program and a computer program carrier are also disclosed.

### BACKGROUND

In order to make failure detection less dependent on a single node, distributed failure detection systems have been proposed. In this manner, the failure detection system avoids, at least to some extent, the problem of having a Single Point of Failure (SPF). Distributed failure detection systems are further well suited for other distributed systems, like cloud infrastructure, grid computing peer-to-peer systems and the like. In these kinds of systems, the distributed detection system is used to monitor a health status of each node and detect potential failure of these nodes. In order to ensure consistence and provide reliable applications/services on top of e.g. the cloud infrastructure, it is vital to have a good failure detection system that can fulfill the requirements like high accuracy, high reliability, lightweight and fast.

In general, failure detection is performed by exchange of so called keep-alive messages between the nodes in a distributed system periodically. There are two types of keep alive messages: heartbeat messages and polling messages.

A heartbeat message is sent periodically from a monitored node to a failure detecting node in order to inform the detecting node about that the monitored node is still alive. If the heartbeat message does not arrive before a timeout expires, the failure detecting node suspects that the monitored node is faulty, or has failed.

A polling message is sent from the failure detecting node to the monitored node. If no reply to the polling message is received, by the failure detecting node, before a timeout expires, the failure detecting node suspects that the monitored node is faulty. The polling message can be exemplified by an ICMP Ping message.

Typically, polling functionality is easier to implement than heartbeat functionality and polling is also less chatty as compared to heartbeat.

A known distributed failure detection system, described in “SWIM: Scalable Weakly-consistent Infection-Style Process Group Memebership Protocol”, by A. Das, I. Gupta, and A. Motivala, published in in Proceedings of the 2002 International Conference on Dependable Systems and Networks, 2002, pp. 303-312, is illustrated in FIG. 1.

With SWIM scalability is achieved by avoiding heart beats, and by using a random peer-to-peer probing of processes instead. This provides constant overhead on group members, as well as constant expected detection time of failures. SWIM has been adopted by some academic works and industry systems, e.g., Consul, Amazon Dynamo.

Hence, as an example, after every T time units, a node Mi selects a random node from its membership list, e.g., Mj, and sends a ping to it. It then waits for an ack message from Mj. If it does not receive the ack within the pre-specified timeout, Mi indirectly probes Mj by randomly selecting k nodes from its neighbors and asks them to send a ping to Mj. Each of these k nodes then sends a ping to Mj on behalf of Mi and on receiving an ack notifies Mi. If, for some reason, none of these processes receive an ack, Mi declares Mj as failed and notifies other neighbors.

Accordingly, at each interval, a random neighbor node is selected to send a probe message. An advantage is that overhead on the network and each node is reduced significantly and the overhead of each node remains constant when the size of the neighbor list increases. A disadvantage is nevertheless that it may take a long time for a neighbor to be selected for probing. Accordingly, a maximum time to detect a failure of that particular neighbor is not bounded by an upper limit. Therefore, in worst case scenarios, it may a take very long time to detect a node's failure though it should be detected eventually since at some point the particular node will, at least from a statistical perspective, be selected.

To tackle this problem of SWIM, a modification of the SWIM system has been proposed. Accordingly, it has been proposed to select the neighbor (i.e. the node to be probed) is based on a round-robin order, instead of randomly selecting the neighbor. The node Mi maintains a list of the known elements of the current neighbor list, and selects ping targets, not randomly from this list, but in the round-robin order.

n is a length of the neighbor list and T is a time interval probing node(s) of the round robin order at a certain position. Hence, it takes n*T for one node to probe its neighboring nodes in the round robin order.

A newly joining member is inserted in the membership list at a position that is chosen uniformly at random. On completing a traversal of the entire list, Mi rearranges the membership list to a random reordering. With this modification, the time to detect a failure neighbor is at most (2n−1)×T. In this manner, the upper time limit for detection of failure has been bounded. Though the average detection time is still the same as the original one, i.e., close to one interval when there is only one potential faulty node at each interval. Still, in worst cases, the detection time is quite long when the size, n, of neighbor list is big.

According to emulations to evaluate the detection time for randomized round-robin based probe list and assume there is only one potential faulty node at each interval. The group size is increased from 20 to 500. And for each size, the emulation is performed 100 times in total. In the emulation, only around 63% faulty node can be detected in one interval, around 86% fault node can be detected in two intervals. In worst cases, some faulty nodes are only detected after 9 intervals. Therefore, in SWIM, the detection time is not balanced, and in some cases, the detect time is quite long.

### SUMMARY

An object may be to improve a failure detection system of the above mentioned kind, while e.g. reducing time for detection of faulty nodes.

According to an aspect, the object is achieved by a method, performed by a system, for managing transmission of probe messages for detection of failure in at least one of a first node, a second node and a third node, referred to as “the nodes”. The system comprises at least the nodes, which are interconnected with each other. Each node of the nodes is configured for managing a member list comprising identifiers of the nodes.

Said each node generates a respective probe list according to a procedure taking said each node and the member list as input. In this manner, said each node becomes configured for transmission of a respective probe message in a set of time intervals for transmission of the probe messages. A set of probe lists comprises the respective probe list for said each node.

Said each node further transmits the respective probe message to a respective node of the nodes according to the respective probe list generated by the procedure. The procedure ensures that the set of probe lists causes said each node to be probed in each time interval of the set of time intervals and by only one other node of the nodes in said each time interval.

According to another aspect, the object is achieved by a system configured for managing transmission of probe messages for detection of failure in at least one of a first node, a second node and a third node, referred to as “the nodes”. The system comprises at least the nodes, which are interconnected with each other. Each node of the nodes is configured for managing a member list comprising identifiers of the nodes.

Said each node of the system is configured for generating a respective probe list for said each node. The respective probe list is generated according to a procedure taking said each node and the member list as input, thereby configuring said each node for transmission of a respective probe message in a set of time intervals for transmission of the probe messages. A set of probe lists comprises the respective probe list for said each node.

Said each node of the system is further configured for transmitting the respective probe message to a respective node of the nodes according to the respective probe list generated by the procedure. The procedure ensures that the set of probe lists causes said each node to be probed in each time interval of the set of time intervals and by only one other node of the nodes in said each time interval.

According to further aspects, the object is achieved by a computer program and a computer program carrier corresponding to the aspects above.

Thanks to that the procedure, i.e. the same procedure, is used by the nodes of the member list, a coordination of the set of probe lists is achieved. As an example, the order of identifiers in the respective probe lists is thus coordinated such that any member, i.e. node, of the member list is probed by only one other node given by the member list in each time interval. Therefore, in any given time interval all nodes of the member list will be scheduled to be probed. As a result, a failure of any node may typically be detected in one time interval.

An advantage is thus that a reduction of maximum time to detect a failure of a node may be reduced, at least on an average, e.g. as compared to the SWIM system utilizing randomized round robin. In particular, the embodiments herein achieve a reduction of detection time for worst case scenarios.

Additionally, another advantage may be that overhead may be reduced thanks to that the system ensures, at least with a certain probability, that any node is only probed by one other node in any time interval.

### BRIEF DESCRIPTION OF THE DRAWINGS

The various aspects of embodiments disclosed herein, including particular features and advantages thereof, will be readily understood from the following detailed description and the accompanying drawings, which are described briefly in the following.

FIG. 1 is a combined signaling and flowchart illustrating a method according to prior art.

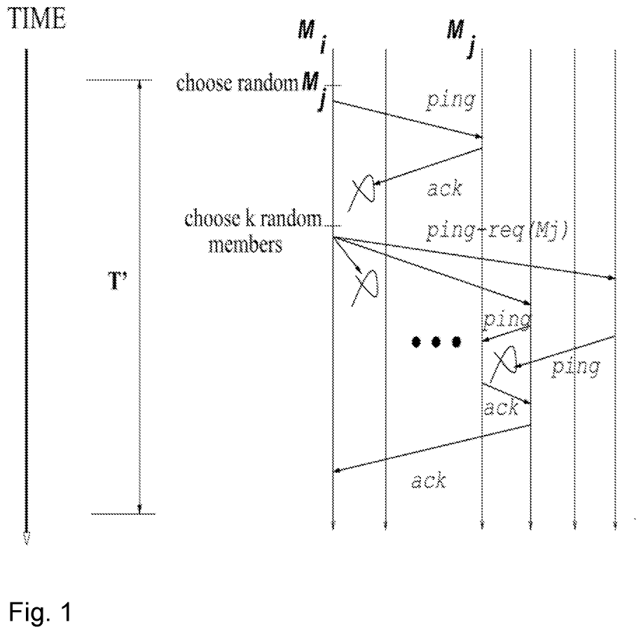

FIG. 2 is a schematic overview of an exemplifying system in which embodiments herein may be implemented.

FIG. 3 is a combined signaling and flowchart illustrating the methods herein.

FIG. 4 is an illustration of an exemplifying procedure according to one embodiment.

FIG. 5 is a block diagram illustrating embodiments of the nodes of the system.

### DETAILED DESCRIPTION

Throughout the following description, similar reference numerals have been used to denote similar features, such as nodes, actions, modules, circuits, parts, items, elements, units or the like, when applicable. In the Figures, features that appear in some embodiments are indicated by dashed lines.

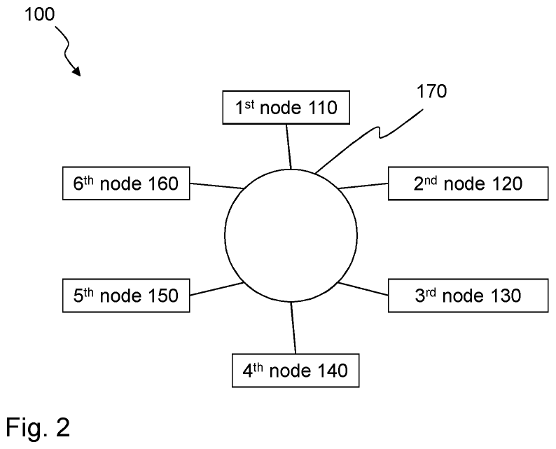

FIG. 2 depicts an exemplifying system 100 in which embodiments herein may be implemented. In this example, the system 100 may be a cloud infrastructure. In other examples, the system 100 may be data center, a computer system, a cloud system, a cloud platform, a communication system or the like. The system 100 may be a portion, such as an underlying infrastructure, of any known communication system, such as any Third Generation Partnership Project (3GPP) system or the like, The system 100 comprises at least a first node 110, a second node 120 and a third node 130. As used herein, the term “node” may refer to a physical, logical or virtual entity of the system 100. Physical entity may refer to a set of hardware resources, such as memory, processor, network interfaces and the like, which may be located within a single casing. Logical or virtual entity may refer to a container in a cloud platform, a virtual machine, an execution environment, an application, a service or the like. Virtual machine may be formed by a collection of hardware resource residing in different casings, racks, sleds, blades or the like, of a so called disaggregated hardware system.

For purposes of illustration, FIG. 2 shows a fourth node 140, a fifth node 150 and a sixth node 160, which may be comprised in the system 100.

The nodes 110-160 may be interconnected with each other, e.g. by means of a communication link 170, which may be a physical, logical or virtual link over the air, wirelessly or by wire.

Each node, such as the first and second nodes 110, 120, of the system 100, may manage a respective probe list. Each node is responsible for maintaining the respective probe list and for sending of probe message(s) to the nodes of the probe list. In this manner, each node may handle its responsibility for detecting failure of other nodes, i.e. neighboring nodes in the system 100. The respective probe list indicates an order and/or a frequency of probing for each node in the probe list. The respective probe list may include identities of nodes to be probed, where e.g. nodes at the beginning of the probe list are probed first.

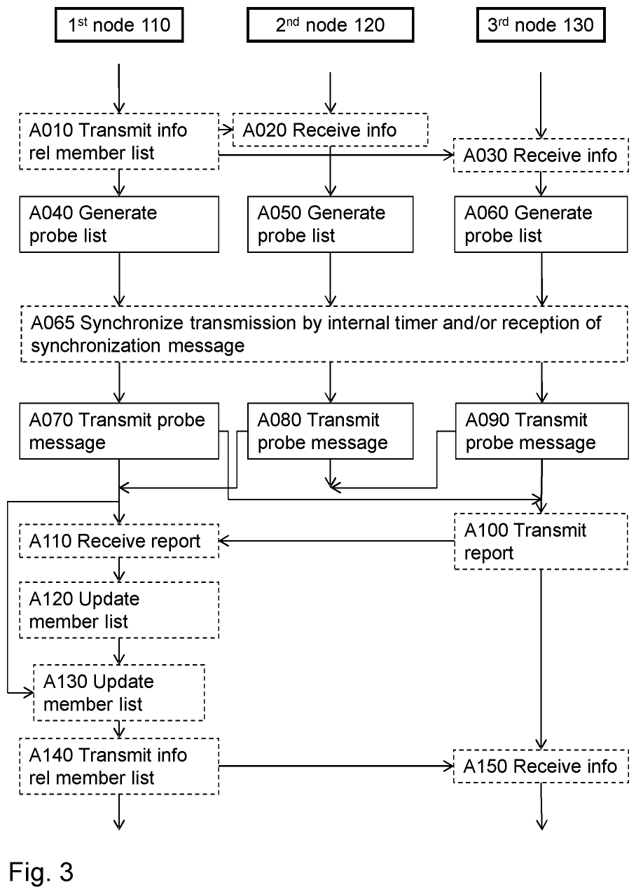

As will be described with reference to FIG. 3, the respective probe list may be generated based on a member list and a procedure, e.g. for generation of a respective probe list for each node 110, 120, 130, 140, 150. 160. In this example, the member list may include identities of the first, second, third, fourth, fifth and sixth nodes 110, 120, 130, 140, 150. 160. The system 100 may of course include other nodes (not shown) that are not included in the member list, or membership list. These other nodes will not be probed by the nodes indicated by the member list.

The procedure used by said each node when generating the respective probe list is the same procedure for the nodes 110, 120, 130. Notably, as will be described below, input to the procedure differs for the different nodes 110, 120, 130 e.g. in that an identifier of the node to execute the procedure is input e.g. together with the member list.

It may here be said that the terms “probing”, “probe” herein refers to a transmission of a probe message, be it an indirect probe message or direct probe message.

FIG. 3 illustrates an exemplifying method according to embodiments herein when implemented in the system 100 of FIG. 2.

The system 100 performs a method for managing transmission of probe messages for detection of failure in at least one of a first node 110, a second node 120 and a third node 130, referred to as “the nodes”.

The system 100 comprises at least the nodes 110, 120, 130, which are interconnected with each other. Each node of the nodes 110, 120, 130 is configured for managing a member list comprising identifiers of the nodes 110, 120, 130.

One or more of the following actions may be performed in any suitable order.

### Action A010

As an example, the first node 110 may transmit information relating to the member list. The information may be transmitted to the second and third nodes 120, 130, i.e. all members of the member list.

The information relating to the member list may be a complete list of identifiers of the nodes in the member list. However, sometimes, the information relating to the member list may include e.g. information about which identifier to remove from the member list. This may be useful in case the entire member list has been transmitted previously, if the entire list is preconfigured or otherwise provided to the members of the list.

The information may comprise information related to the procedure. As an example, the information related to the procedure may indicate how to generate the respective probe list.

See also action A140 below. In action A140 an update of the information relating to the member list is described.

This action may sometimes be performed as multiple actions, e.g. by transmitting identifiers of nodes in the member list as one action and by transmitting the information related to the procedures as another action. Action A140 below may also be performed as multiple actions in a similar way.

### Action A020

Subsequent to action A010, the second node 120 may receive the information relating to the member list. In this manner, the second node 120 may obtain requisite information to be used in action A050. The requisite information may include identifiers of the nodes that are included in the member list and the information related to the procedure.

### Action A030

Subsequent to action A010, the third node 130 may receive the information relating to the member list. In this manner, the third node 130 may obtain requisite information to be used in action A060. The requisite information is exemplified above in action A020.

### Action A040

The first node 110 generates a respective probe list according to the procedure, which takes an identifier of the first node 110 and the member list as input.

In this manner, the first node 110 becomes configured for transmission of a respective probe message in a set of time intervals for transmission of the probe messages. A set of probe lists comprises the respective probe list for generated by the first node 110.

As used herein, the term “time interval” is used to refer to a time slot, a time period or the like, in which a node is scheduled to transmit a respective probe message to another node and to expect a response from the probed node. Roughly, the time interval may indicate how often probe messages are to be transmitted.

The time interval may preferably be at least several times greater than network latency between the nodes given by the member list. In this manner, a difference between when every node of the member list receives the information relating to the member list may be small when compared to the time interval.

The time interval may not be dependent on network latency. Then, the information relating to the member list may include a start time. The start time may be set to a time far enough in the future, so that every node in the member list is assured to receive and process the information relating to the member list before that time. All nodes then start to use their newly created probe lists at the start time. As will be explained further below, the newly created probe lists may be generated at least partially based on the information relating to the member list. When using the start time, it may further be preferred to have synchronized clocks among the nodes e.g. by use of Network Time Protocol (NTP) or any other clock synchronization protocol.

### Action A050

Similarly to action A040, the second node 120 generates a respective probe list according to the procedure, which takes an identifier of the second node 120 and the member list as input.

In this manner, the second node 120 becomes configured for transmission of a respective probe message in the set of time intervals for transmission of the probe messages. The set of probe lists comprises the respective probe list for generated by the second node 120.

### Action A060

The third node 130, similarly to the second node 120 above, generates a respective probe list according to the procedure, which takes an identifier of the third node 130 and the member list as input.

In this manner, the third node 130 becomes configured for transmission of a respective probe message in the set of time intervals for transmission of the probe messages. The set of probe lists comprises the respective probe list for generated by the third node 130.

In view of the above, it is clear that the respective probe lists, generated by the respective node 110, 120, 130, are different, but coordinated. The probe lists are different e.g. because the respective probe list generated by the first node 110 does of course not include the identifier of the first node 110, whereas the probe lists generated by both the second and third nodes 120, 130 do include the identifier of the first node 110. The probe lists are coordinated e.g. because the procedure, i.e. one and the same procedure, has been used for generation of the set of probe lists.

With these actions A040, A050, A060, said each node 110, 120, 130 generates the respective probe list according to the procedure taking said each node, i.e. the identifier thereof, and the member list as input. In this manner, said each node becomes configured for transmission of the respective probe message in the set of time intervals for transmission of the probe messages.

### Action A065

The system 100, e.g. each of the nodes 110, 120, 130, may synchronize the transmission of the respective probe message. In this manner, a synchronization of the transmissions of the probe messages may be achieved.

The synchronization may be triggered by a respective internal timer in each node 110, 120, 130.

The synchronization may be triggered by a synchronization message, which may be received from an external clock connected to each node 110, 120, 130. This may mean that there is one external clock that is connected to the nodes 110, 120, 130.

As an example, the synchronization may mean that the nodes 110, 120, 130 obtain a common understanding of time, i.e. pace of time and what the time is. In this manner, it may be ensured that each node probes a neighbouring node in each time interval of the set of time intervals.

### Action A070

The first node 110 transmits the respective probe message to a respective node of the nodes 110, 120, 130 according to the respective probe list generated by the procedure. In this example, the first node 110 transmits the respective probe message towards the third node 130.

### Action A080

Similarly to action A070, the second node 120 transmits the respective probe message to a respective node of the nodes 110, 120, 130 according to the respective probe list generated by the procedure. In this example, the second node 120 transmits the respective probe message towards the first node 110.

### Action A090

Similarly to action A070, the third node 130 transmits the respective probe message to a respective node of the nodes 110, 120, 130 according to the respective probe list generated by the procedure. In this example, the third node 130 transmits the respective probe message towards the second node 120.

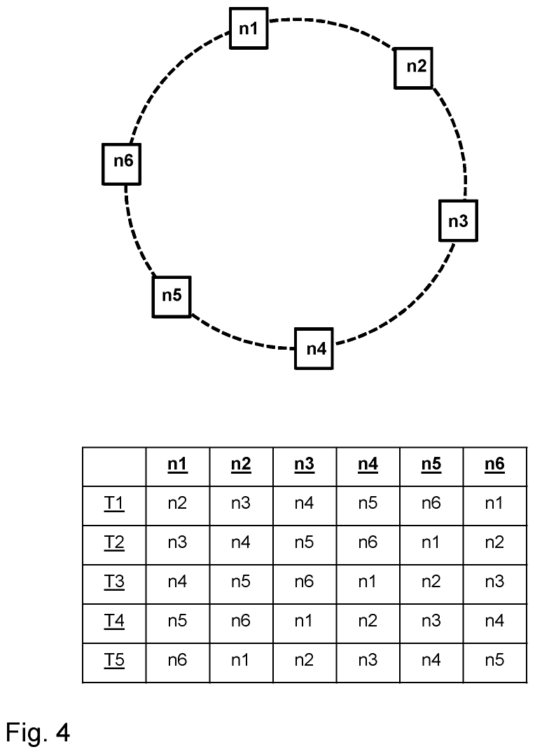

The procedure ensures that the set of probe lists causes said each node to be probed in each time interval of the set of time intervals and by only one other node of the nodes 110, 120, 130 in said each time interval. Expressed differently, the procedure ensures that two nodes never probe towards one and the same node in one and the same time interval of the set of time intervals. The procedure is further exemplified and described with reference to FIG. 4.

In view of action A070, A080, A090, said each node 110, 120, 130 transmits the respective probe message towards a respective node of the nodes 110, 120, 130 according to the respective probe list generated by the procedure.

In some embodiments, referred to as “leader embodiments”, the first node 110 may be configured for coordinating the member list with the second and third nodes 120, 130, and the second and third nodes 120, 130 may be configured for reporting of results relating to the transmission A070, A080, A090 of the respective probe message. The reporting, by the second and third nodes 120, 130 may be directed towards the first node 110. As an example, this means that the set of probe lists are coordinated. The coordination of the set of probe lists may be achieved by that the member list and the procedure for generation of the respective probe lists are coordinated among the nodes 110, 120, 130. This may even apply for other embodiments, i.e. not only the leader embodiments, e.g. when so called peer nodes, e.g. the nodes 110, 120, 130 coordinate the procedure and the member list.

In some examples, this means that one of the nodes of the member list is a so called leader node, or master node, main node, coordinating node or the like. Other nodes, but the leader node, may be referred to as slaves, minions, followers or the like.

Leaders and followers are well studied within computer science; see a consensus protocol known as Raft. In the following, it is assumed that the first node 110 is the leader node and accordingly the second and third nodes 120, 130 are minions. These examples are elaborated on with reference to e.g. one or more of action A100, A110, A120 and A130.

### Action A100

when no response to any one of the probe messages, e.g. any respective probe message, is received, e.g. by the second and third nodes 120, 130, within a time period indicating allowable response time for nodes in the network 100, the second or third node 120, 130 may transmit, to the first node 110, a report indicating that no response to the respective probe message was received within the time period. The report may comprise an indication of the respective node that failed to respond within the time period.

### Action A110

Subsequent to action A100, the first node 110 may receive the report. This action may occur when the second or third node 120, 130 may have transmitted the report. Expressed differently, when the transmitting A100, by the second or third node 120, 130, of the report has been performed, action A110 may be performed.

### Action A120

Subsequent to action A110, the first node 110 may update the member list by excluding the respective node given by the indication from the member list.

### Action A130

When no response to the respective probe messages transmitted by the first node 110 is received, i.e. received by the first node 110, within the time period indicating allowable response time for nodes in the network 100, the first node 110 may update the member list by excluding the respective node—that failed to respond—from the member list.

### Action A140

The first node 110 may transmit information relating to the updated member list to the second or third node 120, 130. In this example, the information relating to the updated member list is transmitted to the third node 130, since the second node 120 may have been reported as failed.

The information relating to the updated member list may comprise one or more of:

the updated member list, e.g. a complete list of identifiers of nodes included in the member list, albeit updated such that any failed nodes no longer are members,

the indication of the respective node that failed to respond, thereby enabling the second or third node 120, 130 to exclude the respective node given by the indication from its member list,

information related to the procedure,

and the like.

### Action A150

Subsequent to action A140, the third node 130 may receive the information relating to the member list.

In view of one or more of action A100, A110, A120, A130, A140 and A150, the following further example may be provided. Whenever a minion node, e.g. the second and/or third node 120, 130, detects a failure of another member, it notifies the leader, which will change the member list and send the updated member list, or at least information on how to update the member list, to all remaining members. In case the leader has failed and is non-operational, a new leader may be elected according to known manners. The new leader may then transmit the updated member list.

Upon reception of information relating to the member list, all nodes will have a common understanding of who the members are. The procedure is thus subsequently applied in order to generate the respective probe lists.

With the leader embodiments above, the first node 110 is the leader, the second node 120 fails and the third node 130 reports the failure of the second node 120, it may also be assumed that the fourth node 140 is present and the fourth node 140 probes the first node 110 and the second node 120 probes the fourth node 140 (rather than the first node 110 as exemplified above).

As an additional observation, two cases may be distinguished with reference to such scenario involving at least four nodes.

In a first case, the second node 120 sent a report about a result of its own probing to the first node 110 before the second node failed, but the second node 120 did not respond to the respective probe message from the third node 130 before it, i.e. the second node 120, failed. The first node 110 will now have contradictory information, since on the one hand all nodes in the member list have reported to the first node, which implies that no node has failed. On the other hand, the first node 110 has received a report, indicating that the second node 120 has failed, from the third node 130.

In a second case, the second node 120 did not sent the report about its own probing to the first node 110 before the second node 120 failed and the second node 120 did also not respond to the respective probe message from the third node 130 before it failed. The first node 110 will now definitively assume the second node 120 to have failed, since the first node 110 did not receive a report from the second node 120 and also the third node 130 has reported the second node 120 as failed. However, the first node 110 lacks a report about a result from the probing of the fourth node 140. Therefore, the first node 110 cannot determine whether or not the fourth node 140 has failed or not. In this particular example, the first node 110 may have noted that the fourth node 140 sent a respective probe message towards the first node 110. In this way, the first node 110 may nevertheless assume that the fourth node 140 is alive. However, in a more general case, involving more than four nodes, the first node 110 may need to wait one time interval in order to allow e.g. any of the nodes still remaining in the member list to report about probing of the fourth node 140.

These are exceptional cases that only occur with a low probability. Therefore, these cases may be of theoretical interest only. E.g. assuming there is a 1% risk of failure of any node, the risk of that there is two or more failed nodes appear in one time intervals is minimal, 1%*1%*50%=0.05‰, where 50% relates to probability that a certain node reported before it failed.

To conclude, according to embodiments of the system 100, the transmission of probe messages may be coordinated as well as synchronized, whereby in each time interval of the set of time interval each node is probed once.

FIG. 4 illustrates an exemplifying procedure according to the embodiments herein. In FIG. 4, the nodes 110, 120, 130, 140, 150 and 150 are denoted by identifiers n1-n6. In this example, the member list thus includes six members, or entries. In the member list, each node may be represented by its respective identifier. The top row of the table of FIG. 4 may represent the member list. Based on the member list, each node could generate a virtual ring, in which all members of the member list, including itself, are placed according to their identifiers. The identifier of each node is assumed to be unique in the system 100.

Since there are six members, 5 time intervals T1-T5 may be required in order to allow any one node to probe each of its members once.

As an example, it may be assumed that the member list is an ordered list that is synchronized among the members in the member list. That is to say, all nodes of the member list have a common understanding of how the list is ordered. If the list is not ordered, the nodes may have a common understanding of how to turn it into an ordered list. As can be seen in FIG. 4, each node, identified by n1-n6 has its respective probe list, each probe list being given by a respective column including five rows T1-T5. Each node may create the respective probe list by traversing the ring in counter clockwise or clockwise order until the node just before itself is reached. For example, node n1 creates the respective probe list (n2, n3, n4, n5, n6), while n3 creates the respective probe list (n4, n5, n6, n1, n2). It can be seen from this Figure, at each interval, every node will be probed once by one of its neighbors. Therefore, the failure of any node may be detected in around one time interval.

Once probing in all the time intervals have been performed, each node restarts probing by probing towards the first node in its respective probe list. In each node, the probing may thus be performed according to a round robin fashion. But thanks to coordination of the set of probe lists, e.g. by means of the member list and the procedure, and the common understanding about ordering of the member list, it may be ensured that only one node is probed by only one other node in each time interval.

This means that the respective probe list for said each node 110, 120, 130 may indicate an order of nodes, neighbouring to said each node 110, 120, 130, thereby causing said each node 110, 120, 130 to probe by transmission of the respective probe message towards one neighbouring node according to the order in each time interval of the set of time intervals.

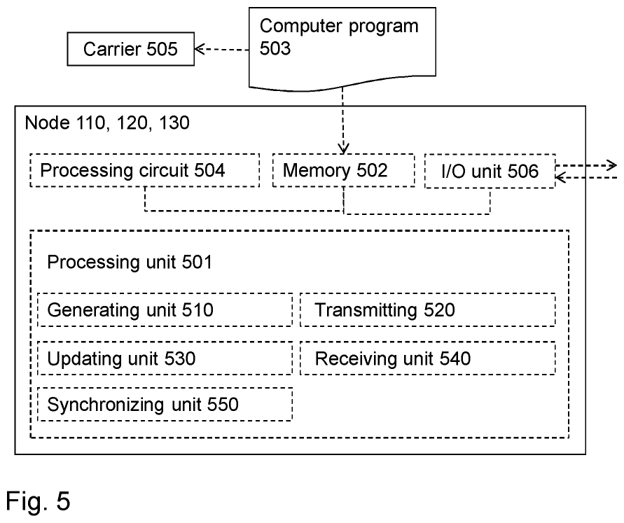

As described above, with reference to FIG. 2, the system 100 comprises at least the first, second and third nodes 110, 120, 130. Each of these nodes is described with reference to FIG. 5, which is a schematic block diagram. In the following the first node 110 serves as an example. The text below applies equally well for the second and third nodes 120, 130.

The first node 110 may comprise a processing unit 501, such as a means for performing the methods described herein. The means may be embodied in the form of one or more hardware units and/or one or more software units. The term “unit” may thus refer to a circuit, a software block or the like according to various embodiments as described below.

The first node 110 may further comprise a memory 502. The memory may comprise, such as contain or store, instructions, e.g. in the form of a computer program 503, which may comprise computer readable code units.

According to some embodiments herein, the first node 110 and/or the processing unit 501 comprises a processing circuit 504 as an exemplifying hardware unit, which may comprise one or more processors. Accordingly, the processing unit 501 may be embodied in the form of, or ‘realized by’, the processing circuit 504. The instructions may be executable by the processing circuit 504, whereby the first node 110 is operative to perform the methods of FIG. 3. As another example, the instructions, when executed by the first node 110 and/or the processing circuit 504, may cause the first node 110 to perform the method according to FIG. 3.

In view of the above, in one example, there is provided a first node 110 for managing transmission of probe messages for detection of failure in at least one of a first node 110, a second node 120 and a third node 130. As mentioned, the system 100 comprises at least the nodes 110, 120, 130, which are interconnected with each other, wherein each node of the nodes 110, 120, 130 is configured for managing a member list comprising identifiers of the nodes 110, 120, 130. Again, the memory 502 contains the instructions executable by said processing circuit 504 whereby the first node 110 is operative for:

for said each node 110, 120, 130, generating a respective probe list according to a procedure taking said each node and the member list as input, thereby configuring said each node for transmission of a respective probe message in a set of time intervals for transmission of the probe messages, wherein a set of probe lists comprises the respective probe list for said each node, and

for said each node 110, 120, 130, transmitting the respective probe message to a respective node of the nodes 110, 120, 130 according to the respective probe list generated by the procedure, wherein the procedure ensures that the set of probe lists causes said each node to be probed in each time interval of the set of time intervals and by only one other node of the nodes 110, 120, 130 in said each time interval.

FIG. 5 further illustrates a carrier 505, or program carrier, which comprises the computer program 503 as described directly above. The carrier 505 may be one of an electronic signal, an optical signal, a radio signal and a computer readable medium.

In some embodiments, the first node 110 and/or the processing unit 501 may comprise one or more of a generating unit 510, a transmitting unit 520, an updating unit 530, a receiving unit 540, and a synchronizing unit 550 as exemplifying hardware units. The term “unit” may refer to a circuit when the term “unit” refers to a hardware unit. In other examples, one or more of the aforementioned exemplifying hardware units may be implemented as one or more software units.

Moreover, the first node 110 and/or the processing unit 501 may comprise an Input/Output unit 506, which may be exemplified by the receiving unit and/or the transmitting unit when applicable.

Accordingly, thanks to that the first, second and third nodes 110, 120, 130 are configured as described herein, it may be said that the system 100 is configured for managing transmission of probe messages for detection of failure in at least one of the first node 110, the second node 120 and the third node 130.

The system 100 comprises at least the nodes 110, 120, 130, which are interconnected with each other. Each node of the nodes 110, 120, 130 is configured for managing a member list comprising identifiers of the nodes 110, 120, 130.

Therefore, according to the various embodiments described above, the first node 110 and/or the processing unit 501 and/or the generating unit 510 is configured for generating a respective probe list for said each node 110, 120, 130, wherein the respective probe list is generated according to a procedure taking said each node 110, 120, 130 and the member list as input, thereby configuring said each node 110, 120, 130 for transmission of a respective probe message in a set of time intervals for transmission of the probe messages, wherein a set of probe lists comprises the respective probe list for said each node 110, 120, 130.

The first node 110 and/or the processing unit 501 and/or the transmitting unit 520 is configured for transmitting the respective probe message to a respective node of the nodes 110, 120, 130 according to the respective probe list generated by the procedure, wherein the procedure ensures that the set of probe lists causes said each node to be probed in each time interval of the set of time intervals and by only one other node of the nodes 110, 120, 130 in said each time interval.

The respective probe list for said each node 110, 120, 130 may indicate an order of nodes, neighbouring to said each node 110, 120, 130, thereby causing said each node 110, 120, 130 to probe by transmission of the respective probe message towards one neighbouring node according to the order in each time interval of the set of time intervals.

The first node 110 may be configured for coordinating the member list with the second and third nodes 120, 130, wherein the second and third nodes 120, 130 are configured for reporting of results relating to the transmission A070, A080, A090 of the respective probe message.

The first node 110 and/or the processing unit 501 and/or the transmitting module 520 may be configured for, when no response to any one of the probe messages is received within a time period indicating allowable response time for nodes in the network 100, transmitting, by the second or third node 120, 130 to the first node 110 or by the first node 110 to the second or third node 120, 130 a report indicating that no response to the respective probe message was received within the time period, wherein the report comprises an indication of the respective node that failed to respond within the time period.

The first node 110 and/or the processing unit 501 and/or the updating unit 530 may be configured for, when no response to the respective probe messages transmitted by the first node 110 is received within a time period indicating allowable response time for nodes in the network 100, updating, by the first node 110 or by the second or third node 120 130, the member list by excluding the respective node that failed to respond from the member list.

In some embodiments, the first node 110 and/or the processing unit 501 and/or the receiving unit 540 may be configured for receiving, by the first node 110, the report.

In these embodiments, the first node 110 and/or the processing unit 501 and/or the updating unit 530 may be configured for updating, by the first node 110, the member list by excluding the respective node given by the indication from the member list.

The embodiments may be applicable when the transmitting, by the second or third node 120, 130, of the report has been performed.

The first node 110 and/or the processing unit 501 and/or the transmitting unit 520 may be configured for transmitting, by the first node 110, information relating to the updated member list to the second or third node 120, 130.

The information relating to the updated member list may comprise one or more of:
the updated member list,
the indication of the respective node that failed to respond, thereby enabling the second or third node 120, 130 to exclude the respective node given by the indication from its member list, and the like.

The first node 110 and/or the processing unit 501 and/or the transmitting unit 520 may be configured for transmitting information relating to the member list, wherein the information comprises information related to the procedure.

The procedure used by said each node 110, 120, 130 when generating the respective probe list may be the same procedure for the nodes 110, 120, 130.

The first node 110 and/or the processing unit 501 and/or the synchronizing unit 550 may be configured for synchronizing the transmission of the respective probe message.

The first node 110 and/or the processing unit 501 and/or the synchronizing unit 550 may be configured for synchronizing the transmission of the respective probe message by being triggered by a respective internal timer in each node.

The first node 110 and/or the processing unit 501 and/or the receiving unit 540 may be configured for receiving a synchronization message from an external clock connected to each node, wherein the synchronizing of the transmission of the respective probe message is triggered by the synchronization message.

As used herein, the term “node”, or “network node”, may refer to one or more physical entities, such as devices, apparatuses, computers, servers or the like. This may mean that embodiments herein may be implemented in one physical entity. Alternatively, the embodiments herein may be implemented in a plurality of physical entities, such as an arrangement comprising said one or more physical entities, i.e. the embodiments may be implemented in a distributed manner, such as on cloud system, which may comprise a set of server machines. In case of a cloud system, the term “node” may refer to a virtual machine, such as a container, virtual runtime environment or the like. The virtual machine may be assembled from hardware resources, such as memory, processing, network and storage resources, which may reside in different physical machines, e.g. in different computers.

As used herein, the term “unit” may refer to one or more functional units, each of which may be implemented as one or more hardware units and/or one or more software units and/or a combined software/hardware unit in a node. In some examples, the unit may represent a functional unit realized as software and/or hardware of the node.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing unit” may include one or more hardware units, one or more software units or a combination thereof. Any such unit, be it a hardware, software or a combined hardware-software unit, may be a determining means, estimating means, capturing means, associating means, comparing means, identification means, selecting means, receiving means, sending means or the like as disclosed herein. As an example, the expression “means” may be a unit corresponding to the units listed above in conjunction with the Figures.

As used herein, the term “software unit” may refer to a software application, a Dynamic Link Library (DLL), a software component, a software object, an object according to Component Object Model (COM), a software function, a software engine, an executable binary software file or the like.

The terms “processing unit” or “processing circuit” may herein encompass a processing unit, comprising e.g. one or more processors, an Application Specific integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a Digital Versatile Disc (DVD), a Blu-ray disc, a software unit that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

As used herein, the expression “transmit” and “send” are considered to be interchangeable. These expressions include transmission by broadcasting, uni-casting, group-casting and the like. In this context, a transmission by broadcasting may be received and decoded by any authorized device within range. In case of uni-casting, one specifically addressed device may receive and decode the transmission. In case of group-casting, a group of specifically addressed devices may receive and decode the transmission.

As used herein, the terms “number” and/or “value” may be any kind of digit, such as binary, real, imaginary or rational number or the like. Moreover, “number” and/or “value” may be one or more characters, such as a letter or a string of letters. “Number” and/or “value” may also be represented by a string of bits, i.e. zeros and/or ones.

As used herein, the terms “first”, “second”, “third” etc. may have been used merely to distinguish features, apparatuses, elements, units, or the like from one another unless otherwise evident from the context.

As used herein, the term “subsequent action” may refer to that one action is performed after a preceding action, while additional actions may or may not be performed before said one action, but after the preceding action.

As used herein, the term “set of” may refer to one or more of something. E.g. a set of devices may refer to one or more devices, a set of parameters may refer to one or more parameters or the like according to the embodiments herein.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1. A method, performed by a system, for managing transmission of probe messages for detection of failure in at least one of a first node, a second node and a third node, referred to as “the nodes”, wherein the system comprises at least the nodes, which are interconnected with each other, wherein each node of the nodes is configured for managing a member list comprising identifiers of the nodes, wherein the method comprises:
for said each node, generating a respective probe list according to a procedure taking said each node and the member list as input, thereby configuring said each node for transmission of a respective probe message in a set of time intervals for transmission of the probe messages, wherein a set of probe lists comprises the respective probe list for said each node, and
for said each node, transmitting the respective probe message to a respective node of the nodes according to the respective probe list generated by the procedure, wherein the procedure ensures that the set of probe lists causes said each node to be probed in each time interval of the set of time intervals and by only one other node of the nodes in said each time interval.

2. The method according to claim 1, wherein the respective probe list for said each node indicates an order of nodes, neighbouring to said each node, thereby causing said each node to probe by transmission of the respective probe message towards one neighbouring node according to the order in each time interval of the set of time intervals.

3. The method according to claim 1, wherein the first node is configured for coordinating the member list with the second and third nodes, wherein the second and third nodes are configured for reporting of results relating to the transmission of the respective probe message, wherein the method comprises:
when no response to any one of the probe messages is received within a time period indicating allowable response time for nodes in the network, transmitting, by the second or third node to the first node, a report indicating that no response to the respective probe message was received within the time period, wherein the report comprises an indication of the respective node that failed to respond within the time period, or
when no response to the respective probe messages transmitted by the first node is received within a time period indicating allowable response time for nodes in the network, updating, by the first node, the member list by excluding the respective node that failed to respond from the member list.

4. The method according to claim 3, when the transmitting, by the second or third node, of the report has been performed, wherein the method comprises:
receiving, by the first node, the report, and
updating, by the first node, the member list by excluding the respective node given by the indication.

5. The method according to claim 3, wherein the method comprises:
transmitting, by the first node, information relating to the updated member list to the second or third node.

6. The method according to claim 5, wherein the information relating to the updated member list comprises one or more of:
the updated member list, and
the indication of the respective node that failed to respond, thereby enabling the second or third node to exclude the respective node given by the indication from its member list.

7. The method according to claim 1, wherein the method comprises:
transmitting information relating to the member list, wherein the information comprises information related to the procedure.

8. The method according to claim 1, wherein the procedure used by said each node when generating the respective probe list is the same procedure for the nodes.

9. The method according to claim 1, wherein the method comprises:
synchronizing the transmission of the respective probe message.

10. The method according to claim 9, wherein the synchronization is triggered by a respective internal timer in each node.

11. The method according to claim 9, wherein the method comprises receiving a synchronization message from an external clock connected to each node, wherein the synchronizing of the transmission of the respective probe message is triggered by the synchronization message.

12. A system configured for managing transmission of probe messages for detection of failure in at least one of a first node, second node and a third node, referred to as “the nodes”, wherein the system comprises at least the nodes, which are interconnected with each other, wherein each node of the nodes is configured for managing a member list comprising identifiers of the nodes, wherein said each node of the system is configured for:
generating a respective probe list for said each node, wherein the respective probe list is generated according to a procedure taking said each node and the member list as input, thereby configuring said each node for transmission of a respective probe message in a set of time intervals for transmission of the probe messages, wherein a set of probe lists comprises the respective probe list for said each node, and
transmitting the respective probe message to a respective node of the nodes according to the respective probe list generated by the procedure, wherein the procedure ensures that the set of probe lists causes said each node to be probed in each time interval of the set of time intervals and by only one other node of the nodes in said each time interval.

13. The system according to claim 12, wherein the respective probe list for said each node indicates an order of nodes, neighbouring to said each node, thereby causing said each node to probe by transmission of the respective probe message towards one neighbouring node according to the order in each time interval of the set of time intervals.

14. The system according to claim 12, wherein the first node is configured for coordinating the member list with the second and third nodes, wherein the second and third nodes are configured for reporting of results relating to the transmission of the respective probe message, wherein the system is configured for:
when no response to any one of the probe messages is received within a time period indicating allowable response time for nodes in the network, transmitting, by the second or third node to the first node, a report indicating that no response to the respective probe message was received within the time period, wherein the report comprises an indication of the respective node that failed to respond within the time period, or
when no response to the respective probe messages transmitted by the first node is received within a time period indicating allowable response time for nodes in the network, updating, by the first node, the member list by excluding the respective node that failed to respond from the member list.

15. The system according to claim 14, when the transmitting, by the second or third node, of the report has been performed, wherein the system is configured for:
receiving, by the first node, the report, and
updating, by the first node, the member list by excluding the respective node given by the indication from the member list.

16. The system according to claim 14, wherein the system is configured for:
transmitting, by the first node, information relating to the updated member list to the second or third node.

17. The system according to claim 16, wherein the information relating to the updated member list comprises one or more of:
the updated member list, and
the indication of the respective node that failed to respond, thereby enabling the second or third node to exclude the respective node given by the indication from its member list.

18. The system according to claim 12, wherein the system is configured for:
transmitting information relating to the member list, wherein the information comprises information related to the procedure.

19. The system according to claim 12, wherein the procedure used by said each node when generating the respective probe list is the same procedure for the nodes.

20. The system according to claim 12, wherein the system is configured for:
synchronizing the transmission of the respective probe message.

21. The system according to claim 20, wherein the system is configured for synchronizing the transmission of the respective probe message by being triggered by a respective internal timer in each node.

22. The system according to claim 20, wherein the system is configured for receiving a synchronization message from an external clock connected to each node, wherein the synchronizing of the transmission of the respective probe message is triggered by the synchronization message.

23. A computer program, comprising computer readable code units which when executed on each node of a system, comprising a first node, a second node, a third node cause the system to perform a method according to claim 1.

24. A carrier providing a computer program according to claim 23, wherein the carrier is one of an electronic signal, an optical signal, a radio signal and a computer readable medium.
